(19) United States
(12) Patent Application Publication
(10) Pub. No.: US 2023/0353682 A1
(43) Pub. Date: Nov. 2, 2023

(54) SYSTEM AND PROCEDURE FOR REAL-TIME HYBRID VOIP CONNECTIONS

(71) Applicant: WHISBI TECHNOLOGIES, S.L., Madrid (ES)

(72) Inventors: José Luis CANTERO ESCOLA, Molins De Rei (ES); Alex BISBE TOSAT, Sant Cugat Del Vallès (ES)

(21) Appl. No.: 17/732,006

(22) Filed: Apr. 28, 2022

(51) Int. Cl. H04M 7/12; H04M 3/42

(52) U.S. Cl. CPC H04M 7/122; H04M 3/42331

(57) ABSTRACT

System and procedure for real-time hybrid VoIP connections between a web page or a mobile application that has implemented a Front-end and a Back-end connected via a communication channel or interface, and at least one automatic private branch exchange (PBX), with DDI (Direct Dialing Inward) functionality and connection to the public switched telephone network (PSTN) in charge of orchestrating the communication and enabling access through at least the PSTN and VoIP protocols.

### CROSS-REFERENCE TO RELATED APPLICATIONS

Not applicable.

### BACKGROUND OF THE INVENTION

### 1. Field of the Invention

The invention falls within the telecommunications sector and more specifically within agreements for the interconnection between switching centers, to work between exchanges having different types of switching equipment.

The invention herein relates to a system and procedure for establishing hybrid VoIP connections, more specifically a system capable of establishing real-time connection between a user and an agent, where the user connects via VoIP and the agent connects via a standard telephone call over the public switched telephone network (PSTN).

### 2. Description of Related Art Including Information Disclosed Under 37 CFR 1.97 and 37 CFR 1.98

Nowadays, users use the Internet more and more to search for product information, contract services, make on-line purchases, request assistance, customer service, etc.; in other words, the Internet has become a consolidated communication channel between users and companies.

However, it is common that in some cases the assistance of a specialized consultant or sales person is required, or the user needs to contact the company that advertises the products on the Internet. For this reason, many of the web pages publish numbers that a user can call to be attended to personally, meaning that the user has to have a telephone line and stop using the Internet channel momentarily, which causes a decrease in the effectiveness of the contact.

To solve this problem there is VoIP technology, an acronym for Voice over Internet Protocol (Voice over Internet Protocol) that allows communication using the Internet channel.

The problem with VoIP technology is that both the user and the agent need to be able to establish the VoIP connection. When this requirement is taken to large call centers, this implies a significant technological change since call center systems are based on communications over the public switched telephone network (PSTN) and not over the Internet.

The object of the invention herein is, therefore, to develop an improved communication system with respect to those systems currently known, providing a solution to the problem described so that the user can establish communication through VoIP technology and be attended to by an agent through the public switched telephone network (PSTN), regardless of where the agent works, that is, remotely, from his/her office or from a call center with a corporate telephone system.

### BRIEF SUMMARY OF THE INVENTION

Based on the prior art, the objective of the invention herein is to provide a system for real-time hybrid VoIP connections, having the features of claim 1.

Another objective of the invention herein is to provide a procedure for making connections via VoIP technology which link up to the public switched telephone network (PSTN), allowing real-time connection.

### BRIEF DESCRIPTION OF THE SEVERAL VIEWS OF THE DRAWINGS

To complement the description being made and in order to facilitate the understanding of the features of the invention, the descriptive memory herein is accompanied by a set of drawings in which, with illustrative and non-limiting character, the following has been represented:

FIG. 1 shows in the system components of the invention in a functional block diagram.

### DETAILED DESCRIPTION OF THE INVENTION

The system for hybrid VoIP connections, the subject-matter of the invention, essentially comprises:
A website or a mobile application having implemented a Front-end (1) and a Back-end (3), connected via a communication channel or interface (2), and
At least one automatic private branch exchange (PBX) (7), with DDI (Direct Dialing Inward) functionality and connection to the public switched telephone network (PSTN), in charge of orchestrating the communication and enabling access through at least the PSTN and VoIP protocols.

The aforementioned Front-end (1) is capable of creating a universally unique identifier (UUID) associated with the communication session to be developed, when a user, through a web page or a mobile application that has implemented said Front-end (1), requests to be connected with an agent through the Front-end (1) itself.

For its part, the Back-end (3) enables the hybridization of the VoIP communication system initiated at the Front-end (1) with the agent's DDI (4) connected to the public switched telephone network (PSTN), for which it has a list of accounts (5) for a VoIP protocol, with the necessary credentials to initiate, modify and terminate the connection, and a list of DDIs (6) connected to the public switched telephone network (PSTN).

At least the Back-end (3) is aware of the agent's DDI (4), either because it is provided from the Front-end (1) or because more sophisticated systems are used as we described in some previously filed inventions.

At least one private branch exchange (PBX) (7) having several functionalities for this connection system; namely:
At least one of these PBXs (7) has pre-configured a list of VoIP accounts (5) and has a routing table to route the calls received in the DDIs (6) of the public switched telephone network (PSTN) to the accounts of the list of accounts (5) for VoIP protocol.
At least one of these PBXs (7) may receive calls associated with a list of DDIs (6) connected to the public switched telephone network (PSTN) (10).
At least one of these PBXs (7) is able to make calls over the public switched telephone network (PSTN) (10) or another configured network.

The procedure for real-time hybrid VoIP connections which starts when a user who wishes to connect with a sales agent via a device having internet access arrives at a web page or a mobile application that has implemented a Front-end (1) and a Back-end (3), comprises the following successive phases:

1. A first phase in which a VoIP communication is established between the Front-end (1) and an automatic private branch exchange PBX (7), via a VoIP account (8) from a list of VoIP accounts (5) available by the Back-end (3), while presenting the user with the necessary controls and messages to manage the VoIP session.

2. The Back-end (3) assigns a free DDI (9) from a list of DDIs (6) to the VoIP account (8), and instructs an automatic private branch exchange PBX (7) to execute a call to the DDI (9) assigned to the VoIP account (8) in the previous phase, placing the call on hold when the user accepts it, or it is accepted automatically.

3. Next, the Back-end (3) instructs the automatic private branch exchange PBX (7) to call the agent, and depending on his/her routing tables, makes the call over a public switched telephone network (PSTN) (10) or other network, and, when the agent receives the call on his/her device (Smartphone, computer, or any other means) and accepts the call, the PBX (7) connects the call to the agent with the call it has on hold from the user assigned to the VoIP account (8) in phase 1).

4. The moment either of the two calls is terminated, with the agent or with the VoIP account (8), the call is not accepted, it is disconnected before reaching the previous point or any other incident, the PBX (7) disconnects the party or parties that are still connected and notifies the Back-end (3) to release the blocked resources in the lists of VoIP accounts (5) and DDIs (6) linked to the session.

This system and procedure efficiently solves the existing problem of connecting a user with VoIP technology to an agent of, for example, a large call center based on communications via the public switched telephone network (PSTN).

### DETAILED DESCRIPTION OF AN EMBODIMENT OF THE INVENTION

In essence, the invention proposes a system for real-time hybrid VoIP and public switched telephone network (PSTN) connections.

The system consists of a web page or a mobile application having implemented a Front-end or user interface (1) and a Back-end (3), connected via a communication interface (2).

The Front-end (1) is the front-end layer of the development, which allows the user to enter and interact with the website. This layer is located over the Back-end (3) and usually comprises drop-down menus, images, icons, colors, graphics and animations, and its basic function is to improve the navigation experience on the front side (of the user), whether in a web environment, a mobile application or a desktop application. The only requirement associated with the invention herein is that said front-end (1) be capable of creating a universally unique identifier (UUID) associated with the communication session to be carried out.

The back-end (3) is that part of the application that lies behind, that is opaque to users. This process includes hardware or software layers that allow the hybridization of two communication systems: the VoIP communication that starts at the Front-end (1) with the agent's DDI connected to the public switched telephone network (PSTN).

The communication interface (2) consists of an API or Application Programming Interface, which comprises a set of definitions and protocols used to design and integrate the application software. In this case, its function is to place the Front-end (1) in communication with the Back-end (2) in charge of the process, although there can also be a direct connection between the Front-end (1) and the Back-end (3).

The Back-end (3) has a list of accounts (5) for a VoIP protocol, usually SIP (Session Initiation Protocol) accounts with the necessary credentials to initiate, modify and terminate the connection. It also has a list of DDIs (Direct Dialing Inward) (6) connected to the public switched telephone network (PSTN).

Additionally, the system includes at least one PBX (Private Branch Exchange) (7). This is in fact a telephone exchange directly connected to the public telephone network by means of trunk lines to manage independently not only internal calls, but also incoming and outgoing calls over any other telephone exchange in charge of orchestrating communication and enabling access to the PSTN, VoIP etc. networks and protocols.

The automatic private branch exchange (PBX) (7) includes the DDI functionality with which the telephone company that provides service to the PBX assigns a range of numbers associated with one or more telephone lines. A DDI allows the company to assign a personal number to each employee, without the need for a separate physical telephone line to be connected to the PBX, so that telephone traffic can be more easily separated and managed. In the system of the invention, upon receiving a connection attempt the Back-end (3) assigns a free DDI from the list of DDIs (6) and blocks it, while updating the PBX (7) so that it forwards the call to the DDI of the assigned agent (4).

At least one automatic private branch exchange (PBX) (7) that includes a connection to the public switched telephone network (PSTN) (10) to make calls through the communications network, given that the system knows the telephone number to connect to the agent, that is, the agent's DDI (4), either because it has been pre-configured or provided in real time as we will explain in the process, or because more sophisticated systems are used.

The automatic private branch exchange PBX (7) has pre-configured a list of VoIP accounts, for example, but not exclusively, under SIP protocol, with permission to receive calls. Said PBX (7), not excluding that it is the same, receives calls associated with a list of DDIs (6) connected to the public switched telephone network (PSTN) (10) where it can receive calls.

At least one of the automatic private branch exchanges PBX (7) must have a routing table (dial plan) to allow routing the calls received in the DDIs (6) of the public switched telephone network (PSTN) to the accounts of the list of accounts (5) for VoIP protocol. Said PBX (7) must also be able to make calls over the public switched telephone network PSTN (10) or other configured network.

When a user, who wishes to connect to a sales agent via a device with internet access, arrives at a web page or a mobile application that has the Front-end (1) implemented, the following process is triggered:

1. The user in question requests connection to an agent through the Front-end or user interface (1), which creates a universally unique identifier associated with each session (UUID).

2. The Front-end (1) reports this request to the Back-end process (3) through the communication interface (2) indicating the universally unique identifier associated with the session (UUID) and the agent's DDI (4) if necessary.

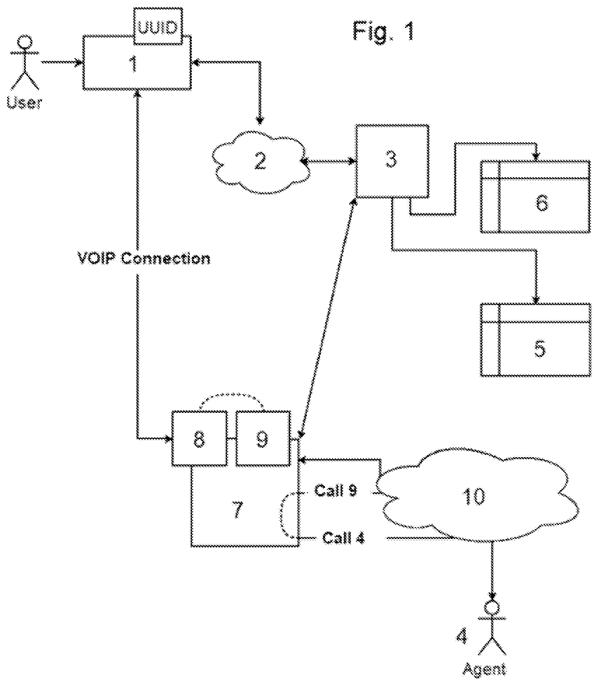

3. The Back-end (3) blocks a free account from the list of VoIP accounts (5) and marks it as blocked, while assigning it the UUID of the session. This specific account is identified as (8) in the diagram of FIG. 1.
a. Optionally: since latency greatly affects the quality of VoIP connections, and one factor affecting latency is the physical distance between points, there could be different lists of VoIP accounts (5) implemented in different PBXs strategically distributed world-wide, and through the user's IP that could be obtained in point 2, detect his/her location and assign the ideal resource either due to distance or business rules.

4. The Back-end (3) provides the Front-end (1) with the necessary parameters to establish a VoIP connection (access point, extension ID, credentials), said parameters being previously stored in the list of VoIP accounts (5) and related to the blocked account (8) in the previous point assigned to that session, identified by the UUID.
a. Optionally: the credentials needed to establish the connection, depending on the system used, could be generated in real time in order to improve security.

5. The Front-end (1), using a market VoIP client, for example https://www.pjsip.org/, establishes the connection between the PBX (7) and the Front-end (1) using the information received in the previous point from the account (8) and, via the communication interface (2), constantly informs the Back-end process (3) of the status of the connection, so as to keep the VoIP account (8) blocked.
a. If, after a configurable period of time, for example 20 seconds, no update has been received from the Front-end (1), the Back-end (3) instructs the PBX (7) to cancel the connection with the VoIP account (8) for this specific session and releases the blocked resources related to the session's UUID.

6. Once the VoIP connection is established, the Front-end (1) communicates said connection to the Back-end (3) via the interface (2). Likewise, the Front-end (1) presents the user with the necessary controls and messages to manage the VoIP session, for example, the option to accept the call, disconnect the call, manage volume, etc. depending on the specific configuration of the user interface.

7. The Back-end (3) assigns a free DDI (9) from the list of DDIs (6) to the VoIP account (8) blocking it. Said DDI (9) will remain in a blocked state as long as the associated VoIP account (8) is blocked.
a. This association could be previously performed in a one-to-one format, avoiding this real-time association, but that would lessen the versatility of the invention.

8. The Back-end (3) updates the PBX (7) so that calls received on said DDI (9) are forwarded to the associated VoIP account (8), instructing it to execute a call to the DDI (9) assigned to the VoIP account (8).
a. Optionally: the PBX (7) could be instructed to call the VoIP account (8) directly without having to go through the assigned DDI (9), but this diminishes the power of the invention in case of using different or multiple PBXs.

9. The PBX (7) calls the assigned DDI (9), which is received at the PBX (7) and routed to the VoIP account (8) and, when the user accepts the call, or it is accepted automatically, it puts the call on hold in a queue notifying the Back-end (3) of this occurrence.

10. The Back-end (3) instructs the PBX (7) to call the agent providing his/her DDI (4), said DDI having been obtained because it was preconfigured, was communicated in one of the previous steps, for example in step 2, or because more sophisticated systems are used as described in some previously filed inventions.
a. Optionally, the call to the agent can be identified by his/her DDI (4) with the DDI (9) as CallerID or CND.

11. The PBX (7) calls the agent's DDI (4), and depending on its routing tables or dial plan, it will make the call over the PSTN or the appropriate network.

12. The agent receives the call on his/her device, Smartphone, computer, etc. and, when the agent accepts the call, the PBX (7) detects that the call has been accepted by the agent and connects the call to the agent with the call it has on hold from the user, notifying the Back-end (3).
a. Optionally, the order of the connection can be changed, connecting first with the agent on his/her DDI (4) and then with the user's DDI (9). The order does not alter the result.

13. The PBX (7) notifies the Back-end (3) that it has connected the agent and the VoIP account (8).

14. If the process does not follow the defined flow at any given moment, the call is not accepted, is disconnected before reaching the previous point or any other incident, and the process is cancelled, thus releasing the blocked resources (5, 6) linked to the session's ID.

15. The moment either of the two calls is terminated, with the agent or with the VoIP account (8), the PBX (7) detects it, disconnecting the party that still remains connected and notifies the Back-end (3) which releases the resources (5, 6) linked to the session.

In an embodiment variant, the list of VoIP credentials (5) and the list of DDIs (6) are created dynamically; currently there are PBXs as a service, for example Twilio, which would allow the creation of VoIP accounts (5) or DDIs dynamically, i.e. it would not be necessary to have them pre-defined, the Back-end (3) would be responsible for creating them on demand.

Having sufficiently described the nature of the invention, as well as an example of preferred embodiment, it is hereby stated for the appropriate purposes that the materials, shape, size and arrangement of the described elements may be modified, provided that this does not involve an alteration of the essential features of the invention claimed below.

We claim:

1. A system for real-time hybrid VoIP connections, comprising:
a web page or a mobile application having implemented a Front-end and a Back-end, connected via a communication channel or interface, and
at least one automatic private branch exchange (PBX), with DDI/DID (Direct Dialing Inward) functionality and connection to the public switched telephone network (PSTN), responsible for orchestrating the communication and enabling access through at least the PSTN and VoIP protocols;
wherein said Front-end is capable of creating a universally unique identifier (UUID) associated with the communication session to be developed, when a user through a web page or a mobile application that has implemented said Front-end requests connection with an agent through said Front-end;
wherein the Back-end is capable of enabling the hybridization of the VoIP communication system initiated at the Front-end with the agent's DDI connected to the public switched telephone network (PSTN), for which it has a list of accounts for a VoIP protocol, with the necessary credentials to initiate, modify and terminate the connection and a list of DDIs connected to the public switched telephone network (PSTN);
wherein the automatic private branch exchange (PBX):
has pre-configured a list of VoIP accounts and has a routing table in order to route the calls received on the DDIs of the PSTN to the accounts of the list of accounts for VoIP protocol;
can receive calls associated with a list of DDIs connected to the PSTN; and
has the ability to make calls via the PSTN or other configured network.

2. System according to claim 1, wherein the communication interface comprises an API or Application Programming Interface capable of communicating the Front-end with the Back-end in charge of the process.

3. System according to claim 1, wherein the communication interface comprises a direct connection between the Front-end and the Back-end.

4. System according to claim 1, wherein the telephone number to connect with the agent, i.e. the agent's DDI, is pre-configured at the Back-end.

5. System according to claim 1, wherein the telephone number to connect with the agent, i.e. the agent's IDD, is set in real time by the Back-end.

6. Procedure for real-time hybrid VoIP connections, which starts when a user who wishes to connect with a sales agent via a device having internet access arrives at a web page or a mobile application that has implemented a Front-end and a Back-end, comprising the following phases:
1) a first phase in which a VoIP communication is established between the Front-end (1) and an automatic private branch exchange PBX, through a VoIP account from a list of VoIP accounts available by the Back-end, while presenting the user with the necessary controls and messages to be able to manage the VoIP session,
2) the Back-end assigns a free DDI from a list of DDIs to the VoIP account, and instructs an automatic private branch exchange PBX to execute a call to the DDI assigned to the VoIP account in the previous phase, placing the call on hold when the user accepts it, or it is accepted automatically,
3) the back-end instructs the automatic private branch exchange to call the agent providing the agent's assigned DDI and the PBX, depending on its routing tables, makes the call over a public switched telephone network (PSTN) or other appropriate network, and, when the agent receives the call on his/her device (Smartphone, computer, or any other means) and accepts the call, the PBX connects the call to the agent with the call it has on hold from the user assigned to the VoIP account in phase 1,
4) when either of the two calls is terminated, with the agent or with the VoIP account, the call is not accepted, it is disconnected before reaching the previous point or any other incident, the PBX disconnects the party or parties that are still connected and notifies the Back-end to release the blocked resources in the lists of VoIP accounts and DDIs linked to the session.

7. Procedure according to claim 6, wherein the first phase in which a VoIP communication is established between the Front-end and an automatic private branch exchange PBX, is subdivided into the following phases:
a) the Front-end creates a universally unique identifier associated with the session (UUID),
b) the Front-end reports the communication request to the Back-end through the communication interface indicating the universally unique identifier associated with the session (UUID),
c) the Back-end blocks a free account from a list of VoIP accounts and marks it as blocked, while assigning the UUID of the session,
d) the Back-end provides the Front-end with the parameters necessary to establish a VoIP connection, said parameters being previously stored in the list of VoIP accounts and related to the blocked account in the previous point, assigned to said session and identified by the UUID,
e) the Front-end establishes the connection between the PBX and the Front-end using the information received in the previous point from the VoIP account and constantly informs the Back-end process, via the communication interface, of the connection's status in order to keep the VoIP account blocked,
f) once the VoIP connection has been made, the Front-end informs the Back-end of the connection via the interface, while providing the user with the necessary controls and messages to be able to manage the VoIP session.

8. Procedure according to claim 6, wherein the second phase in which the automatic private branch exchange PBX executes a call to a DDI assigned to the VoIP account and puts the call on hold, is subdivided into the following phases:
a) the Back-end assigns a free DDI from the list of DDIs to the VoIP account blocking it, said DDI will remain blocked as long as the associated VoIP account is blocked,
b) the Back-end updates the PBX so that calls received on said DDI are forwarded to the associated VoIP account, instructing it to execute a call to the DDI assigned to the VoIP account.
c) the PBX calls the assigned DDI, which is received at the PBX and routed to the VoIP account and, when the user accepts the call, or it is accepted automatically, the PBX puts it on hold in a queue and notifies the Back-end of this occurrence.

9. Procedure according to claim 6, wherein the third phase in which the automatic private branch exchange PBX connects the call it has established with the agent with the call it has on hold from the user assigned to the VoIP account, is subdivided into the following phases:
a) the Back-end instructs the PBX to call the agent, providing his/her DDI.
b) the PBX calls the agent's DDI and depending on its routing tables or dial plan, it will make the call over the PSTN or the appropriate network;
c) the agent receives the call on his/her device (Smartphone, computer, or similar device) and, when the agent accepts the call, the PBX detects that the call has been accepted by the agent and connects the call to the agent with the call it has on hold from the user and notifies the Back-end,
d) the PBX notifies the Back-end hat it has connected the agent and the VoIP account.

10. Procedure, according to claim 6, wherein different lists of VoIP accounts are available, implemented in different PBXs strategically distributed world-wide, and through the IP assigned to the user, his/her location is detected and the suitable resource is assigned either due to distance or business rules.

11. Procedure according to claim 6, wherein the necessary credentials to establish a VoIP connection in the list of VoIP accounts and which are related to the blocked account and assigned to said session, are generated in real time.

12. Procedure according to claim 6, wherein if once the Front-end has established the connection with the PBX, a configurable period of time elapses without the Back-end receiving any update from the Front-end, it instructs the PBX to cancel the connection with the VoIP account for this specific session and releases the blocked resources related to the session's UUID.

13. Procedure according to claim 6, wherein the Back-end updates the PBX in order to execute the call directly to the VoIP account without the need to pass through the assigned DDI.

14. Procedure according to claim 6, wherein the VoIP accounts or DDIs are created dynamically by the Back-end, without the need to pre-define them.
